(19) United States
(12) Patent Application Publication
(10) Pub. No.: US 2010/0329815 A1
(43) Pub. Date: Dec. 30, 2010

(54) Trim Panel Retainer Assembly

(76) Inventors: Nicholas Jackson, JR., Davisburg, MI (US); Ryan E. Ward, Royal Oak, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/787,437

(22) Filed: May 26, 2010

Related U.S. Application Data
(60) Provisional application No. 61/220,616, filed on Jun. 26, 2009.

(51) Int. Cl. F16B 21/16

(52) U.S. Cl. 411/357

(57) ABSTRACT

A retainer assembly comprises a pin including a head and a flange defining a groove therebetween for engaging a first panel. A grommet includes a collar encompassing the pin and flexible arms extending from a hinge point at the collar. The assembly is initially in a shipped position wherein the flexible arms extend along the pin and are maintained in a pocket between ribs of the pin. The pin is inserted through a second panel until the collar engages the second panel. The grommet bends at the hinge points allowing the flexible arms to slide out of the pocket and adjustable engage the pin and the second panel until the second panel is maintained in position by the flexible arms, collar, and flange. Upon removing the assembly from the panels, the grommet adjusts back to the shipped position and the assembly is ready for reuse.

### CROSS REFERENCE TO RELATED APPLICATION

This application claims the benefit of application Ser. No. 61/220,616 filed Jun. 26, 2009.

### BACKGROUND OF THE INVENTION

1. Technical Field

This present invention is directed to panel retainers, and more particularly, to retainer assemblies for automotive interior applications.

2. Discussion

Retainer assemblies are often used in automotive vehicle interior applications to retain two panels in position relative to one another. For example, the retainer assembly can be used to secure a door trim panel to a supporting metal sheet of the door. Oftentimes existing retainers include a sophisticated two piece design providing for easy separation of the panels. The two pieces can be formed of materials different from one another, with one material being more flexible to accommodate panels of various thicknesses. For example, an existing retainer assembly includes a plastic base having sides extending from a head to a tip and an adjustable metal clip extending along the sides and around the base. The retainer assembly can be inserted into the panels so that the plastic base engages the first panel and the flexible metal clip engages the second panel. However, upon removing the two-piece retainer from the panels, the metal clip and base are pulled apart or separated from one another, which either prevents the retainer assembly from being re-used, or requires re-assembling the retainer assembly. Further, the use of multiple parts separating from one another and multiple materials, such as the plastic base and metal clip, creates significant manufacturing and assembly costs.

### SUMMARY OF THE INVENTION

In view of the above, the need exists for a re-useable retainer assembly for accommodating panels of various thicknesses, which can be efficiently manufactured and assembled. The present invention provides for such an improved retainer assembly. The retainer assembly includes a pin extending longitudinally between a first end and a second end and a grommet encompassing and adjustably engaging the pin. The pin defines a groove for engaging a first panel. The grommet includes a collar encompassing the pin between the groove and the first end and a plurality of flexible arms extending from the collar along the pin toward the first end. The grommet also includes a hinge point between the collar and each of the flexible arms allowing the grommet to bend at the hinge points for allowing the flexible arms to adjustably engage the pin and a second panel.

The retainer assembly can be easily inserted into the two panels. A force is applied to the retainer assembly to engage the first panel by the groove. As the pin is inserted into a hole of the second panel, the grommet slides along the pin toward the second end and bends at the hinge points, allowing the flexible arms to move outwardly and adjust from a shipped position to an assembled position. By bending at the hinge points, the flexible arms of the grommet can engage second panels having a range of thicknesses. The retainer assembly is removed from the panels by applying a force thereto. As the retainer assembly is removed from the second panel, the grommet again bends at the hinge points allowing the flexible arms to move inwardly and the grommet slides along the pin adjusting back to the shipped position. Upon returning to the shipped position, the retainer assembly can be re-used. The grommet and pin remain adjustably engaged to one another before and after inserting the retainer assembly into the two panels, thus reducing manufacturing and assembly costs. The pin and grommet of the retainer assembly can be formed of a single plastic material, which also provides for low manufacturing costs.

### BRIEF DESCRIPTION OF THE DRAWINGS

The present invention will become more fully understood from the detailed description given below, the appended claims, and the accompanying drawings in which:

FIG. 1 is perspective view of a first embodiment of the subject invention in a shipped position;

FIG. 2 is perspective view of the first embodiment in a first assembled position;

FIG. 3 is a side view of the first embodiment in the shipped position;

FIG. 4 is a top view of the first embodiment;

FIG. 5 is a perspective view of a pin of the first embodiment;

FIG. 6A is a side cross sectional view of the first embodiment in the shipped position;

FIG. 6B is a side cross sectional view of the first embodiment in the first assembled position;

FIG. 6C is a is a side cross sectional view of the first embodiment in a second assembled position;

FIG. 7 is perspective view of the grommet of the first embodiment;

FIG. 8 is a perspective view of the first embodiment engaging a first panel and aligned with a slot of a second panel;

FIG. 9A is a perspective and partial cross sectional view of the first embodiment in the shipped position and aligned with a slot of a second panel;

FIG. 9B is a perspective and partial cross sectional view of the first embodiment in the shipped position and disposed in the slot of the second panel;

FIG. 9C is a perspective and partial cross sectional view of the first embodiment in the first assembled position and disposed in the slot of the second panel;

FIG. 10 is a cross sectional view of the pin and a plurality of teeth of the first embodiment;

FIG. 11A is a side cross sectional view of a second embodiment of the subject invention in a shipped position;

FIG. 11B is a side cross sectional view of the second embodiment of the subject invention in an assembled position;

FIG. 12 is a top view of the second embodiment;

FIG. 13A is a cross sectional view of a third embodiment in a shipped position wherein the head of the pin defines a hole;

FIG. 13B is a cross sectional view of the third embodiment in an assembled position;

FIG. 14 is a top view of the third embodiment;

FIG. 15A is a perspective view of the second embodiment in the shipped position; and

FIG. 15B is a perspective and partial cross sectional view of the second embodiment in the shipped position.

### DETAILED DESCRIPTION OF THE INVENTION

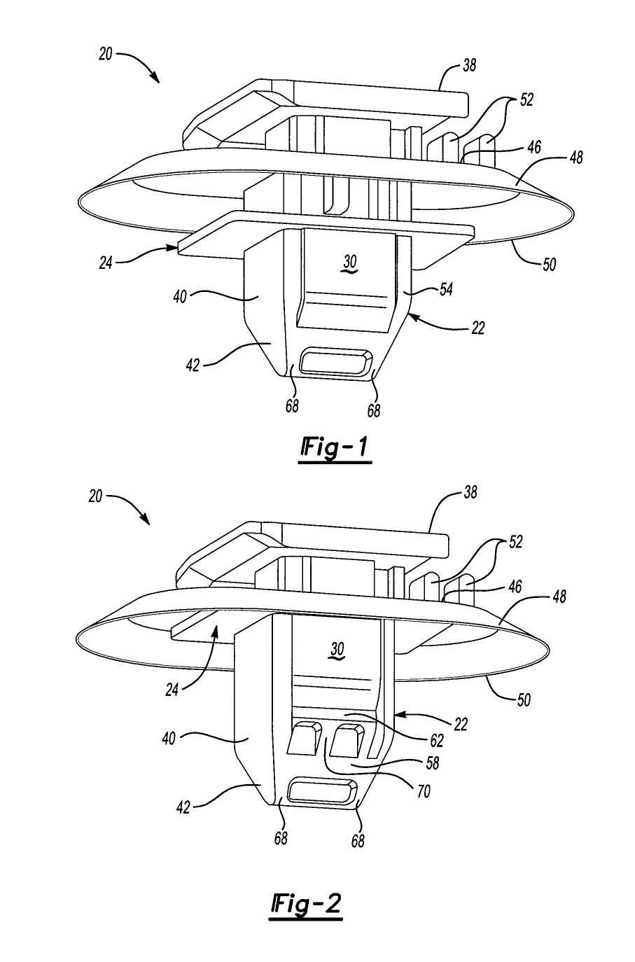

Referring to the Figures, wherein like numerals indicate corresponding parts throughout the several views, a retainer assembly 20 including a pin 22 encompassed by a grommet 24 is generally illustrated in FIGS. 1 and 2. The pin 22 defines a groove 26 for engaging a first panel 28 and the grommet 24 includes flexible arms 30 for adjustably engaging the pin 22 as the pin 22 passes through a second panel 32. The retainer assembly 20 adjusts from a shipped position, as shown in FIG. 1, to an assembled position, as shown in FIG. 2, to maintain the first panel 28 and second panel 32 in position relative to one another.

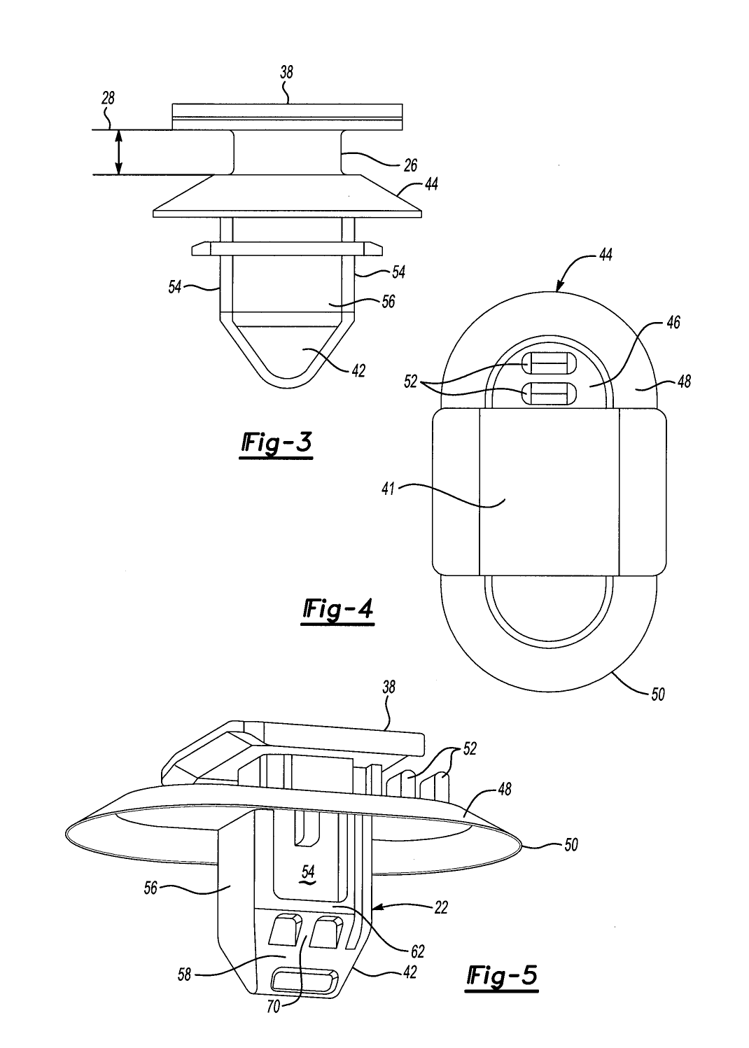

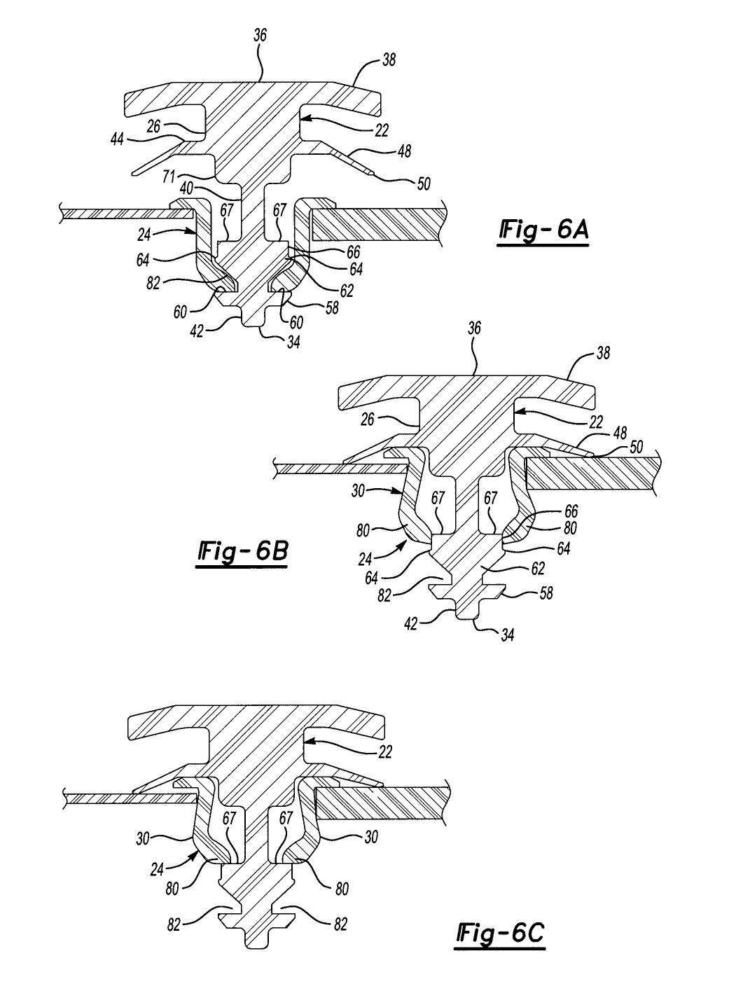

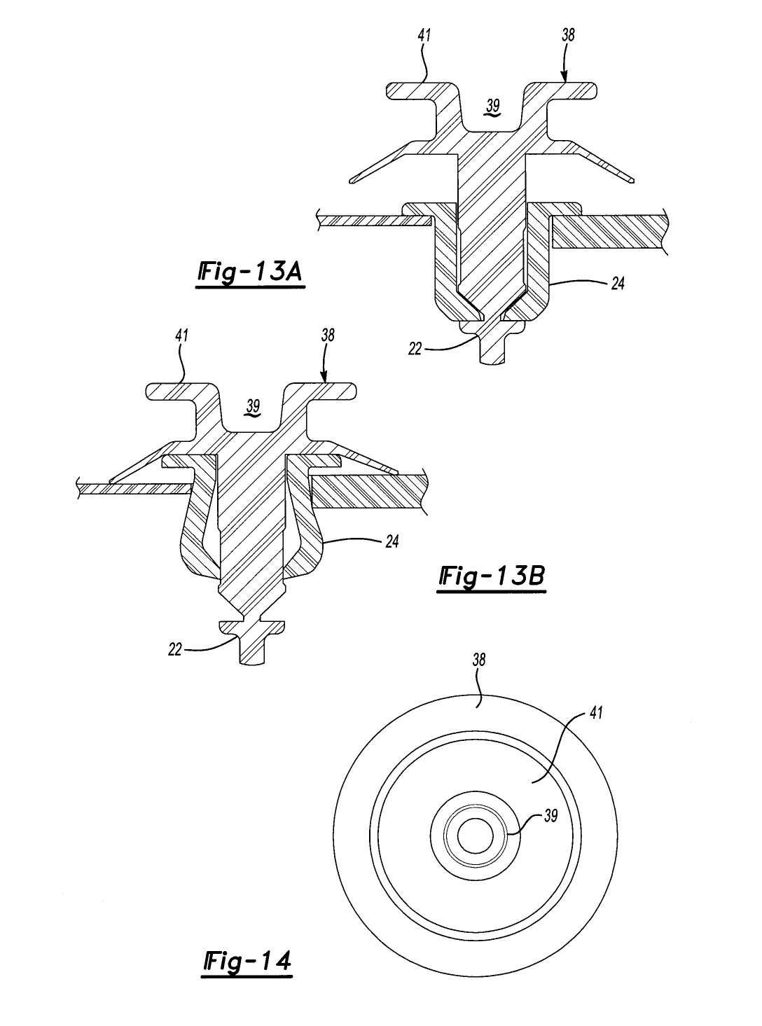

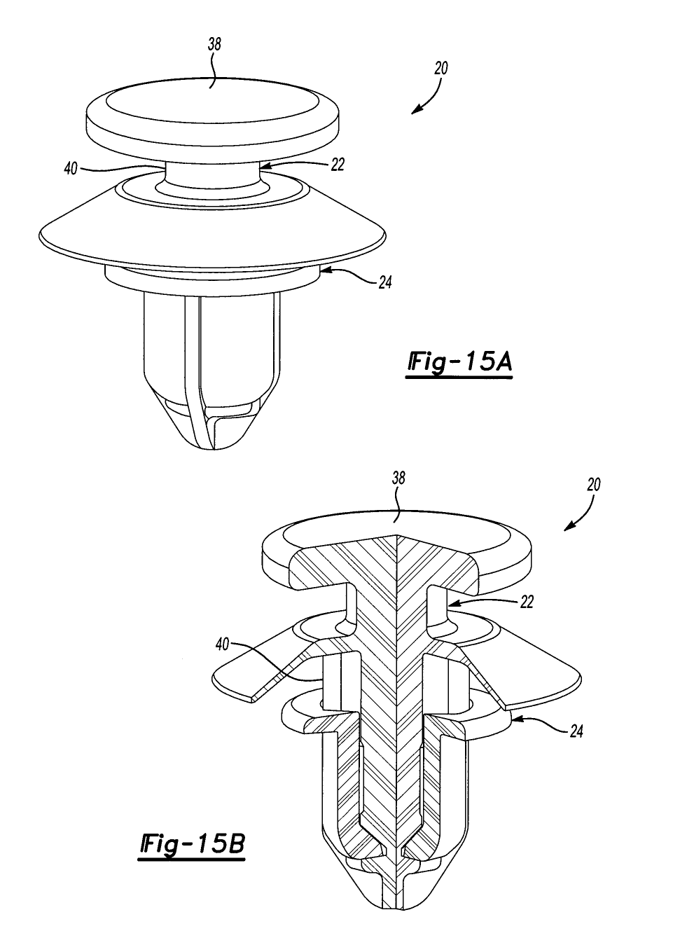

The pin 22 of the retainer assembly 20 extends longitudinally between a first end 34 and a second end 36, as shown in FIGS. 6A and 6B. The pin 22 includes a head 38 extending radially outwardly from the first end 34 and a shank portion 40 extending transverse to the head 38 and longitudinally from the head 38 to a tip portion 42. The head 38 presents a flat surface 41 at the second end 36, as shown in FIG. 4. The width of the tip portion 42 decreases from the shank portion 40 to the second end 36, as shown in FIG. 3. In one embodiment, the shank portion 40 of the pin 22 includes a rectangular cross section, as shown in FIG. 10. In a second embodiment, the head 38 and shank portion 40 of the pin 22 includes a circular cross section, and the shank portion 40 includes a cylindrical shape, as shown in FIGS. 15A and 15B. In yet another embodiment, as shown in FIGS. 13 and 14, the head 38 includes a hole 39 extending into the flat surface 41 at the center of the head 38. The hole 39 of the head 38 allows a user to grasp the head 38 when removing the retainer assembly 20 from the panels 28, 32. Although not shown, in other embodiments the pin 22 includes other cross sectional shapes.

The pin 22 also includes a flange 44 extending radially outwardly from the shank portion 40. The flange 44 presents a flange platform 46 facing and parallel to the head 38 to define the groove 26 between the head 38 and the flange platform 46, as shown in FIGS. 3 and 4, for engaging and supporting the first panel 28. In one embodiment, the flange platform 46 includes an oval perimeter, as shown in FIG. 4. The head 38 and flange platform 46 extend across one another, as shown in FIG. 4. The flange 44 also includes an umbrella 48 extending conically outwardly and downwardly from the flange platform 46 away from the head 38 to an umbrella edge 50 for providing a sealing engagement between the umbrella edge 50 and the second panel 32, as shown in FIGS. 6B and 6C. In one embodiment, a plurality of teeth 52 extend upwardly from the flange platform 46 between the flange 44 and the head 38, as shown in FIGS. 1, 2, and 4, and 10, for limiting rotation of the retainer assembly 20 relative to the first panel 28 and the second panel 32.

The pin 22 includes a plurality of engagement sides 54 extending between the first end 34 and the flange 44. The engagement sides 54 are spaced from one another about the shank portion 40 by support sides 56, as shown in FIGS. 3 and 5. In one embodiment, the pin 22 includes a pair of the engagement sides 54 facing opposite one another, as shown in FIGS. 1, 2, and 3. In another embodiment, the pin 22 includes four engagement sides 54 spaced from one another by the supporting sides 54, 56, as shown in FIGS. 15A and 15B. Although not shown, in other embodiments the pin 22 can include a different number of engagement sides 54 and support sides 56.

Each of the engagement sides 54 of the pin 22 include a first rib 58 extending transversely from the tip portion 42 adjacent the first end 34 to present a first rib platform 60, as shown in FIG. 6A. Each of the engagement sides 54 also include a second rib 62 extending transversely from the shank portion 40 adjacent the tip portion 42. The second rib 62 is disposed between the first rib 58 and the flange 44. The first rib 58 and second rib 62 define a pocket 82 therebetween for supporting and engaging the grommet 24 when the assembly is in the shipped position, as shown in FIG. 6A, which will be discussed further below. Although not shown, in other embodiments the pin 22 includes other configurations for engaging the grommet 24 in the shipped position.

Each of the second ribs 62 of the pin 22 present a locking surface 66 extending longitudinally therealong for engaging the grommet 24 when the retainer assembly is in the first assembled position, as shown in FIG. 6B. A locking ledge 64 extends outwardly from the second rib 62 between the locking surface 66 and the pocket 82 for supporting the grommet 24 in the first assembled position, which will be discussed further below. Although not shown, in other embodiments the pin 22 includes other configurations for engaging the grommet 24 in the first assembled position.

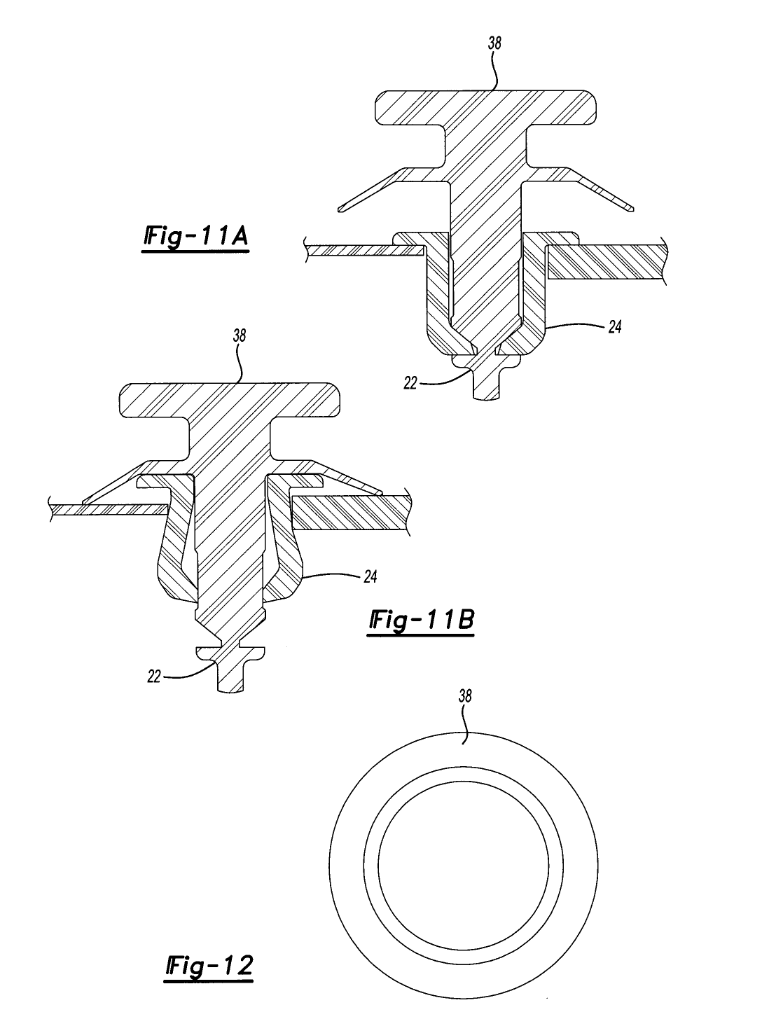

In one embodiment, as shown in FIGS. 6A, 6B, and 6C, the second rib 62 presents a second rib platform 67 extending transversely from the locking surface 66 inwardly toward the shank portion 40 of the pin 22. The second rib platform 67 supports the grommet 24 in a second assembled position, as shown in FIG. 6C. In another embodiment, the locking surface 66 is integral with the shank portion 40 above the locking ledge 64 so that the second rib 62 does not present the second rib platform 67, as shown in FIGS. 11-15.

In one embodiment, each of the engagement sides 54 include a plurality of first rib supports 68 for supporting the first rib 58, as shown in FIG. 2. The first rib supports 68 extend outwardly from the tip portion 42 beneath the first ribs 58, between the second end 36 and the first rib 58. Each of the engagement sides 54 of the pin 22 also include a plurality of second rib supports 70 for supporting the second rib 62, as shown in FIG. 5. The second rib supports 70 extend outwardly from the pin 22 beneath the first ribs 58, between the first rib 58 and the second rib 62. Each of the engagement sides 54 also include a plurality of flange supports 71 extending outwardly form the shank portion 40 beneath the flange 44, between the second rib 62 and the flange 44, as shown in FIG. 6A, for supporting the flange 44. The supports 68, 70, 71 are integral with the associated ribs 58, 62 and flange 44 as shown in the Figures.

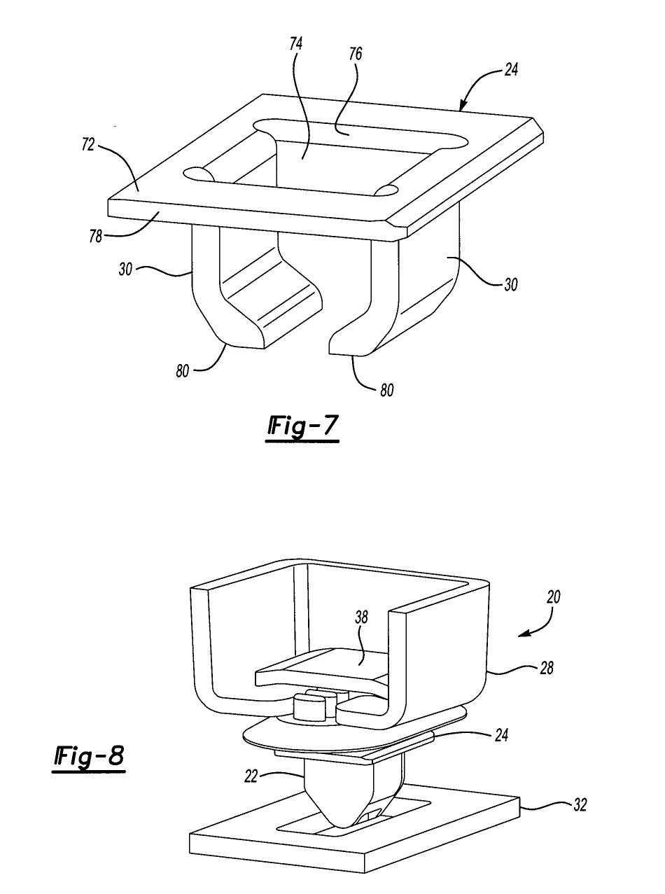

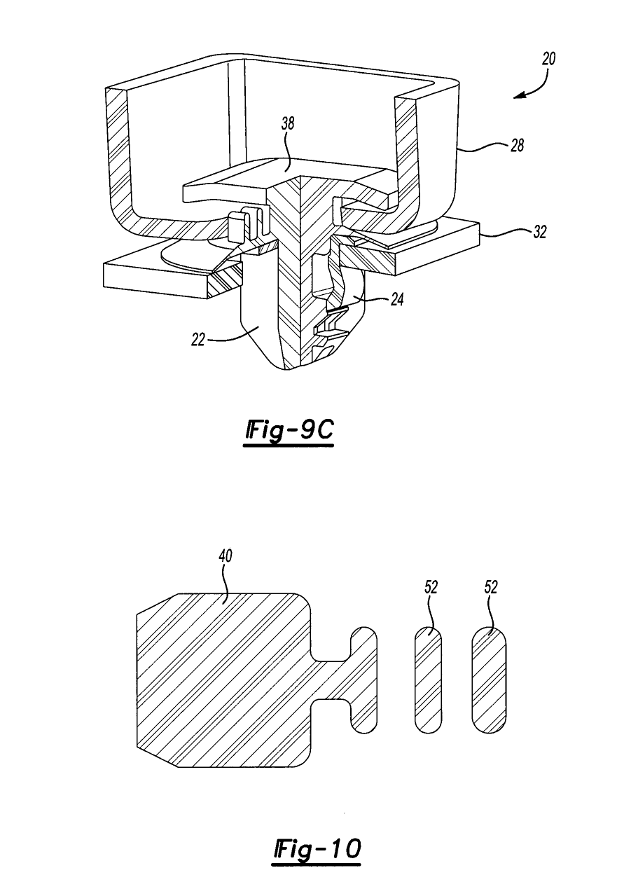

As alluded to above, the grommet 24 adjustably engages and moves along the pin 22 between the shipped position and the assembled position, as shown in FIGS. 9A-9C. The grommet 24 encompasses the pin 22 and adjustably engages the pin 22 between the flange 44 and the first rib 58. The grommet 24 includes a collar 72 defining a collar opening 74 for encompassing the shank portion 40 of the pin 22. In one embodiment, the collar opening 74 includes a rectangular perimeter, as show in FIG. 7. In another embodiment, the collar opening 74 includes a circular perimeter, as shown in FIGS. 15A and 15B. When the retainer assembly 20 is in the assembled position, the collar 72 of the grommet 24 rests on the second panel 32. The collar 72 extends transverse to the shank portion 40 of the pin 22 and is spaced from and generally parallel to the head 38. The collar 72 extends from an inside edge 76 facing inwardly toward the pin 22 to an outside edge 78 facing outwardly of the pin 22.

The grommet 24 includes a plurality of flexible arms 30 extending downwardly from the inside edge 76 of the collar 72. The flexible arms 30 are spaced from one another by portions of the collar 72. The grommet 24 encompasses the pin 22 so that the flexible arms 30 extend along the engagement sides 54 of the pin 22, as shown in FIGS. 6A, 6B, 6C and 7 and are spaced from one another by the support sides 56 of the pin 22. Each flexible arm 30 of the grommet 24 extends along one of the engagement sides 54 of the pin 22. The retainer assembly 20 includes an equal number of flexible arms 30 and engagement sides 54.

The flexible arms 30 each include an engagement finger 80 at the end thereof extending inwardly to engage the engagement side 54. As the grommet 24 moves from the shipped position to the assembled position, the engagement fingers 80 travel along the engagement sides 54 of the pin 22. The grommet 24 includes a hinge point between the collar 72 and each of the flexible arms 30. The hinge point has a thickness less than the thickness of the collar 72 and flexible arms 20, allowing the grommet 24 to bend at the hinge point. The hinge point allows the flexible arms 30 to move inwardly toward one another and toward the pin 22 and outwardly away from one another and away from the pin 22.

In one embodiment, as shown in FIG. 7, the grommet 24 of the retainer assembly 20 includes two of the flexible arms 30 facing opposite one another and spaced from one another by the support sides 56 of the pin 22. The flexible arms 30 include a generally rectangular shape extending across the shank portion 40 of the engagement sides 54, as shown in FIG. 7. In another embodiment, the grommet 24 includes four of the flexible arms 30 spaced from one another by the support sides 56, as shown in FIG. 15A. The flexible arms 30 shown in FIGS. 15A and 15B include a concave shape extending across the shank portion 40 of the engagement sides 54. Although not shown, in other embodiments the grommet 24 includes other configurations adjustably engaging the pin 22 and moving along the pin 22 between the shipped position and the assembled position. The retainer assembly 20, including the pin 22 and grommet 24, is formed of a single material, typically a plastic material, such as acetal, but can be formed of other materials.

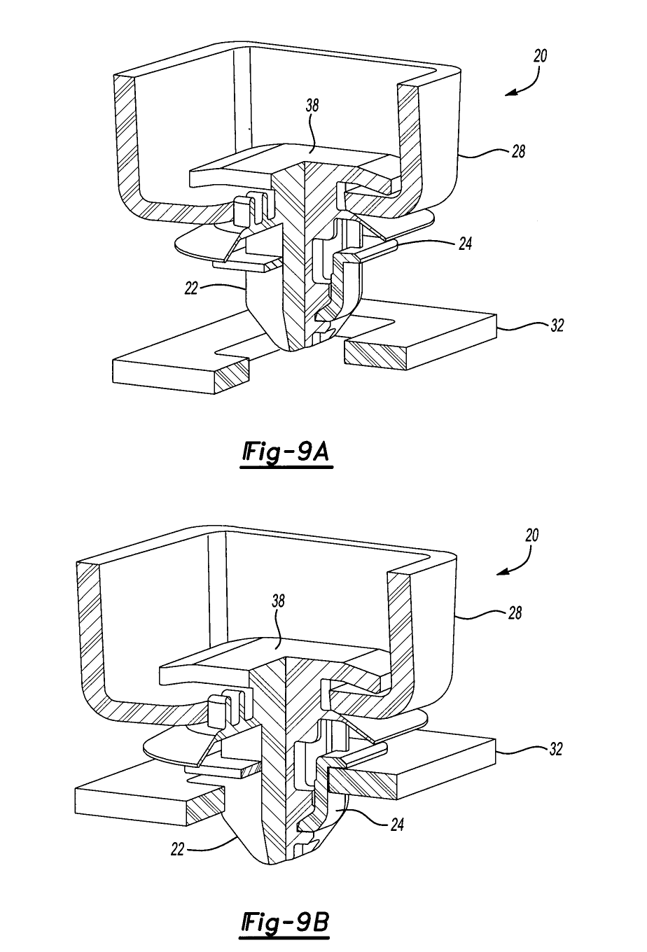

As stated above, the retainer assembly 20 is used for retaining two panels 28, 32 in a predetermined position relative to one another. As alluded to above and shown in FIGS. 8 and 9, the retainer assembly 20 is first disposed in the shipped position, wherein the engagement fingers 80 of the grommet 24 are maintained in the pocket 82 of the pin 22 between the ribs 58, 62. The pin 22 of the retainer assembly 20 engages the first panel 28 at the groove 26 of the pin 22, which is between the head 38 and flange 44. As stated above, the first panel 28 is typically a dog house panel allowing the groove 26 of the pin 22 to be pressed into the open slot of the dog house panel, as show in FIGS. 8 and 9. The retainer assembly 20 is maintained by a pinch point of the dog house of the first panel 28.

The retainer assembly 20 engaging the first panel is positioned so that the tip portion 42 is aligned with a slot of the second panel 32, as shown in FIG. 8. The second panel 32 is typically a sheet metal, as shown in FIGS. 8 and 9. The tip portion 42 of the pin 22 is inserted through the slot of the second panel 32, followed by the engagement fingers 80 of the grommet 24. After the tip portion 42 passes through the slot, the second panel 32 engages the collar 72 of the grommet 24 and forces the grommet 24 along the shank portion 40 toward the flange 44 as the pin 22 continues to be inserted through the slot of the second panel 32. As the grommet 24 travels upward toward the flange 44, the flexible arms 30 move outwardly away from the pin 22 on the inboard of the second panel 32 until the engagement fingers 80 slide out of the pocket 82 and over the locking ledge 64 and the second panel 32 is secured in position, as shown in FIGS. 6B and 6C. The second panel 32 is maintained in position by the umbrella 48 of the pin 22 and collar 72 and flexible arms 30 of the grommet 24, as shown in FIGS. 8 and 9. As alluded to above, the flexible arms 30 move about the hinge point of the grommet 24, both inwardly toward the pin 22 and outwardly away from the pin 22, to accommodate second panels 32 having a range of thicknesses. In one embodiment, the engagement fingers 80 engage the locking surface 66 above the locking ledge 64 while maintaining the second panel 32 in position, as shown in FIG. 6B. In another embodiment, the engagement fingers 80 move further along the pin 22 and rest on the second rib platform 67, as shown in FIG. 6C.

The retainer assembly 20 is removed from the first panel 28 by applying a horizontal force to the pin 22 so that the groove disengages the dog house. Next, a longitudinal force is applied to the pin 22 so that the engagement fingers 80 disengage from the locking surface 66 and the pin 22 and grommet 24 together are removed from the second panel 32. Upon disengaging the second panel 32, the retainer assembly 20 adjusts from the assembled position back to the shipped position. For example, the head 38 can be pulled upward from the second panel 32. The engagement between the engagement fingers 80 and locking surface 66 is tuned to release at a certain range of extraction force per retainer assembly 20. The force required to remove the retainer assembly 20 from the panels 28, 32 is greater than the force required to insert the retainer assembly 20 into the panels 28, 32. As the pin 22 retracts from the slot of the second panel 32, the grommet 24 slides down the pin 22 and the engagement fingers 80 move inwardly toward the pin 22 and move back into the pockets 82 of the pin 22, as shown in FIG. 9A. The engagement fingers 80 of the flexible arms 30 are again maintained in the pockets 82 of the pin 22 and the retainer assembly 20 is ready to be reused for retaining two panels 28, 32. The retainer assembly 20 is undamaged and requires no re-assembly prior to reuse.

The foregoing discussion discloses and describes an exemplary embodiment of the present invention. One skilled in the art will readily recognize from such disclosure, and form the accompanying drawings and claims that various changes, modifications and variations can be made therein without departing from the true spirit and fair scope of the invention as defined by the following claims.

1. A retainer assembly 20 for retaining a first panel 28 and a second panel 32 in position relative to one another comprising:
a pin 22 extending longitudinally between a first end 34 and a second end 36;
a grommet 24 encompassing and adjustably engaging said pin 22;
said pin 22 defining a groove 26 for engaging a first panel 28;
said grommet 24 including a collar 72 encompassing said pin 22 between said groove 26 and said first end 34;
said grommet 24 including a plurality of flexible arms 30 extending from said collar 72 along said pin 22 toward said first end 34; and
said grommet 24 including a hinge point between said collar 72 and each of said flexible arms 30 allowing said grommet 24 to bend at said hinge points for allowing said flexible arms 30 to adjustably engage said pin 22 and a second panel 32.

2. A retainer assembly 20 as set forth in claim 1 wherein said hinge points have a thickness less than the thickness of said collar 72 and less than the thickness of said flexible arms 30 for allowing said grommet 24 to bend at said hinge points.

3. A retainer assembly 20 as set forth in claim 1 wherein said flexible arms 30 of said grommet 24 move inwardly toward said pin 22 and outwardly away from said pin 22 at said hinge points.

4. A retainer assembly 20 as set forth in claim 1 wherein each of said flexible arms 30 include an engagement finger 80 at the free end thereof extending inwardly for engaging said pin 22.

5. A retainer assembly 20 as set forth in claim 1 wherein said collar 72 extends from an inside edge 76 facing inwardly to an outside edge 78 facing outwardly of said pin 22 and said flexible arms 30 extend from said inside edge 76 toward said first end 34 of said pin 22.

6. A retainer assembly 20 as set forth in claim 1 wherein said pin 22 includes engagement sides 54 spaced from one another by support sides 56 and each of said flexible arms 30 of said grommet 24 extend along one of said engagement sides 54 and is spaced from the adjacent flexible arm 30 by a support side 56.

7. A retainer assembly 20 as set forth in claim 1 wherein said pin 22 and said grommet 24 are formed of the same material.

8. A retainer assembly 20 as set forth in claim 7 wherein said material includes acetal.

9. A retainer assembly 20 as set forth in claim 1 wherein said pin 22 includes a first rib 58 and a second rib 62 extending outwardly therefrom and defining a pocket 82 therebetween for supporting and engaging said flexible arms 30 of said grommet 24 in a shipped position.

10. A retainer assembly 20 as set forth in claim 9 wherein said pin 22 includes engagement sides 54 presenting said ribs 58, 62 and being spaced from one another by support sides 56 and each of said flexible arms 30 of said grommet 24 extend along one of said engagement sides 54.

11. A retainer assembly 20 as set forth in claim 9 wherein said pin 22 includes rib support 68, 70 extending outwardly from said pin 22 beneath said ribs 58, 62 for supporting said ribs 58, 62.

12. A retainer assembly 20 as set forth in claim 9 wherein said second rib 62 includes a locking surface 66 extending longitudinally therealong for engaging said flexible arms 30 of said grommet 24 in an assembled position.

13. A retainer assembly 20 as set forth in claim 12 wherein second rib 62 includes a locking ledge 64 extending outwardly from said second rib 62 between said locking surface 66 and said pocket 82.

14. A retainer assembly 20 as set forth in claim 13 wherein said pin 22 includes a shank portion 40 and said ribs 58, 62 extend transversely outwardly from said shank portion 40 and said locking surface 66 of said second rib 62 is integral with said shank portion 40.

15. A retainer assembly 20 as set forth in claim 12 wherein said second rib 62 presents a second rib platform 67 extending transversely inwardly from said locking surface 66.

16. A retainer assembly 20 as set forth in claim 1 wherein said pin 22 includes a head 38 extending radially outwardly from said second end 36 and a flange 44 extending radially outwardly from said pin 22 between said head 38 and said grommet 24 to define said groove 26 therebetween.

17. A retainer assembly 20 as set forth in claim 16 wherein said pin 22 includes a plurality of teeth 52 extending upwardly form said flange 44 between said flange 44 and said head 38 for limiting rotation of said flange 44 relative to said first panel 28 and said second panel 36.

18. A retainer assembly 20 as set forth in claim 1 wherein said pin 22 includes a head 38 extending radially outwardly from said second end 36.

19. A retainer assembly 20 as set forth in claim 18 wherein said head 38 presents a flat surface 41 at said second end 36 and defines a hole 39 extending from said flat surface 41 toward said first end 34.

20. A retainer assembly 20 as set forth in claim 1 wherein said pin 22 includes a flange 44 extending radially outwardly from said pin 22 between said groove 26 and said grommet 24 for engaging said second panel 32.

21. A retainer assembly 20 as set forth in claim 20 wherein said flange 44 extends conically outwardly toward said first end 34 for providing a sealing engagement with said second panel 32.

22. A retainer assembly 20 as set forth in claim 20 wherein said pin 22 includes at least one flange support 71 extending outwardly from said pin 22 beneath said flange 44 for supporting said flange 44.

23. A retainer assembly 20 as set forth in claim 1 wherein said grommet 24 includes a pair of said flexible arms 30 facing opposite one another.

24. A retainer assembly 20 as set forth in claim 1 wherein said grommet 24 includes four of said flexible arms 30 spaced from one another about said pin 22.

25. A retainer assembly 20 for retaining a first panel 28 and a second panel 32 in position relative to one another comprising:
a pin 22 extending longitudinally between a first end 34 and a second end 36;
a grommet 24 encompassing and adjustably engaging said pin 22;
said pin 22 including a head 38 extending radially outwardly from said first end 34;
said head 38 presenting a flat surface 41 at said first end 34;
said pin 22 including a tip portion 40 adjacent said second end 36;
said pin 22 including a shank portion 40 extending transverse to said head 38 and longitudinally between said head 38 and said tip portion 40;
said tip portion 40 having a width and decreasing in said width from said shank portion 40 to said first end 34;
said pin 22 including a flange 44 extending radially outwardly from said shank portion 40;
said flange 44 presenting a flange platform 46 facing and parallel to said head 38;
said flange platform 46 and said head 38 defining a groove 26 therebetween for receiving a first panel 38;
said flange platform 46 including a perimeter having an oval shape;
said flange 44 including an umbrella 48 extending conically outwardly and downwardly from said flange platform 46 away from said head 38 to an umbrella edge 50 engaging a second panel 32 and providing a sealing engagement between said umbrella edge 50 and said second panel 32;
said pin 22 including a plurality of engagement sides 54 extending between said first end 34 and said flange 44;
said engagement sides 54 being spaced from one another about said shank portion 40;
said pin 22 including a plurality of support sides 56 spacing said engagement sides 54 from one another;
said support sides 56 being spaced by said engagement sides 54;
each of said engagement sides 54 including a first rib 58 extending transversely from said tip portion 42 adjacent said first end 34;
said first rib 58 presenting a first rib platform 60 facing and parallel to said head 38 of said pin 22;
each of said engagement sides 54 including a second rib 62 extending transversely from said shank portion 40 between said first rib 58 and said flange 44;
said first rib 58 and said second rib 62 defining a pocket 82 therebetween for supporting and engaging said grommet 24 in a shipped position;
second rib 62 presenting a locking surface 66 extending longitudinally therealong for engaging said grommet 24 in said assembled position;
said second rib 62 including a locking ledge 64 extending outwardly therefrom between said locking surface 66 and said pocket 82 for supporting said grommet in said assembled position;
each of said engagement sides 54 of said pin 22 including a plurality of first rib supports 68 extending outwardly from said tip portion 42 between said second end 36 and said first rib 58 for supporting said first rib 58;
each of said engagement sides 54 including a plurality of second rib supports 70 extending outwardly from said shank portion 40 between said first rib 58 and said second rib 62 for supporting said second rib 62;
each of said engagement sides 54 including a plurality of flange supports 71 extending outwardly from said shank portion 40 between said second rib 62 and said flange 44 for supporting said flange 44;
said grommet 24 including a collar 72 defining a collar opening 74 engaging said pin 22 along said shaft portion 40 between said flange 44 and said second rib 62;
said collar 72 extending transverse to said shank portion 40 from an inside edge 76 facing inwardly toward said pin 22 to an outside edge facing outwardly of said pin 22;
said collar 72 being generally parallel to said head 38;
said grommet 24 including a plurality of flexible arms 30 extending downwardly from said inside edge 76 of said collar 72;
each of said flexible arms 30 extending from said collar 72 along one of said engagement sides 54 toward said tip portion of said pin 22 said flexible arms 30 being spaced from one another by said support sides 56 of said pin 22;
said grommet 24 including a number of said flexible arms 30 equal to a number of said support sides 56 of said pin 22
said grommet 24 including a hinge point between said collar 72 and each of said flexible arms 30;
said hinge point having a thickness less than the thickness of said collar 72 and less than the thickness of said flexible arms 30 for allowing said grommet 24 to bend at said hinge points for moving said flexible arms 30 inwardly toward said pin 22 and outwardly away from said pin 22;
said flexible arms 30 being spaced from one another by portions of said collar 72 free of said hinge points;
each of said flexible arms 30 including an engagement finger 80 at a free end thereof and extending inwardly for engaging said engagement side 54 of said pin 22;
each of said flexible arms 30 including a generally rectangular perimeter extending across said engagement side 54;
said pin 22 and grommet 24 formed of a single common material; and
said common material being acetal.

26. A retainer assembly 20 as set forth in claim 25 wherein said shank portion 40 of said pin 22 presents a rectangular cross section;
said pin 22 includes a plurality of teeth 52 extending upwardly form said flange platform 46 between said flange 44 and said head 38 for limiting rotation of said retainer assembly 20 relative to said first panel 28 and said second panel 36;
said pin 22 including a pair of said engagement sides 54 facing opposite one another and spaced from one another by said support sides 56;
said second rib 62 of said pin 22 presenting a second rib platform 67 extending transversely from said locking surface 66 inwardly toward said shank portion 40 of said pin 22;
said second rib platform 67 supporting said grommet 24 in an assembled position; and
said grommet 24 includes a pair of said flexible arms 30 facing opposite one another and spaced from one another by said support sides 56 of said pin 22.

27. A retainer assembly 20 as set forth in claim 25 wherein said locking surface 66 is integral with said shank portion 30 above said locking ledge 64.

28. A retainer assembly 20 as set forth in claim 25 wherein said shank portion 40 of said pin 22 presents a circular cross section;
said pin 22 includes four of said engagement sides 54 spaced from one another by said support sides 56; and
said grommet 24 includes four of said flexible arms 30 spaced from one another by said support sides 56 of said pin 22.

29. A retainer assembly 20 as set forth in claim 25 wherein said head 38 of said pin 22 includes a hole 39 extending from said flat surface 41 of said head 38 toward said shank portion 40.
